(19) United States
(12) Patent Application Publication
(10) Pub. No.: US 2008/0116014 A1
(43) Pub. Date: May 22, 2008

(54) ELEVATOR INSTALLATION WITH A BELT, BELT FOR SUCH AN ELEVATOR INSTALLATION, METHOD OF PRODUCING SUCH A BELT, COMPOSITE OF SUCH BELTS AND METHOD FOR ASSEMBLY OF SUCH A COMPOSITE IN AN ELEVATOR INSTALLATION

(76) Inventor: Ernst Ach, Ebikon (CH)

Correspondence Address: FRASER CLEMENS MARTIN & MILLER LLC, 28366 KENSINGTON LANE, PERRYSBURG, OH, 43551, US

(21) Appl. No.: 11/837,007

(22) Filed: Aug. 10, 2007

Related U.S. Application Data
(60) Provisional application No. 60/822,118, filed on Aug. 11, 2006.

(30) Foreign Application Priority Data
Aug. 11, 2006 (EP) 06118824.9

(51) Int. Cl. B66B 11/04; F16H 7/02

(52) U.S. Cl. 187/252; 474/153

(57) ABSTRACT

An elevator installation includes an elevator car, a drive and a belt arrangement with at least one belt, wherein the belt has a belt body in which a tensile carrier arrangement is arranged and which has a first contact surface on a first cross-sectional side in the direction of the height of the belt and a second contact surface on a second cross-sectional side opposite the first cross-sectional side in the direction of the height of the belt. The ratio of the maximum width to the maximum height of the belt is in a range of 0.8 to 1.0, preferably in the range of 0.9 to 1.0 and particularly at 1.0.

### CROSS-REFERENCE TO RELATED APPLICATION

This application claims the benefit of U.S. provisional patent application Ser. No. 60/822,118 filed Aug. 11, 2006.

### FIELD OF THE INVENTION

This invention relates to an elevator installation with a belt, to a belt for such an elevator installation, to a method for producing such a belt, to a composite of such belts and to a method for assembling such a composite in an elevator installation.

### BACKGROUND OF THE INVENTION

An elevator installation comprises an elevator car and usually a counterweight, which are movable in an elevator shaft or along free-standing guide rails. For producing the movement the elevator installation has at least one drive with at least one respective drive pulley or drive shaft, which, by way of one or more belts, supports the elevator car and the counterweight and/or transmits the required drive forces thereto.

In that case the elevator car and the counterweight can be connected with the drive by way of the same belt or belts. Alternatively, the elevator car and the counterweight can also be respectively coupled with the drive by way of separate belts in such a manner that the counterweight is raised when the elevator car is lowered and conversely. Whereas the drive pulley or drive shaft exerts tension forces on the drive belts in order to raise the elevator car or the counterweight, pure support belts are merely deflected over deflecting elements, particularly deflecting rollers, and accept a constant part of weight force of the elevator car and the counterweight. However, drive and support belts are preferably identical.

A belt according to the present invention can be used for any of the above-described functions, thus not only as a drive belt, but also as a support belt, as one of several belts and/or as a belt which is fastened to the elevator car and/or to the counterweight. Accordingly, drive pulleys or drive shafts and deflecting rollers are generally termed belt wheels in the following.

Such belts for elevator installations usually comprise a belt body of elastomers, for example polyurethane (PU) or ethylene-polypropylene-diene rubber (EPDM). In order to transmit the tension forces, tensile carriers in the form of steel and/or plastics material cords are embedded in the belt body. The cords can be constructed as single wires or preferably built-up from singly or multiply stranded wires. They are advantageously arranged in the neutral axis of the belt cross-section in which no tensile or compressive stresses arise during looping around of a belt wheel.

Conventionally, use is made in elevator installations of flat belts, in detail belts of which the width “w” parallel to the belt wheel axis is significantly larger than its height “t” in radial direction of the belt wheel. Such flat belts have, by virtue of their small height, a small geometrical moment of inertia about their transverse axis and at the same time, by virtue of their large width, a large geometrical moment of inertia about their longitudinal and height axis. They are thus advantageously very resilient with respect to their transverse axis, but at the same time very stiff about their longitudinal and height axis. Thus, they can on the one hand satisfactorily loop around the belt wheels and on the other hand twist or bend only slightly in the free run sections. In addition, the arrangement of the tensile carriers adjacent to one another in the neutral axis leads to a large width of the belt by comparison with height.

WO 2006/000500 A1 accordingly proposes a flat belt for elevator installations which is built up from a first part belt and a second part belt connected therewith, each extruded from PU, wherein tensile carriers are arranged in the neutral plane of bending of the flat belt.

In order to increase the pressing pressure at the belt wheel and thus the traction capability or drive capability for the same radial force and thus the same bearing loading and belt tension, it is known from EP 1 555 234 B1 to provide the belt body, which is of flat belt type, with wedge ribs which co-operate with grooves, which are formed to be substantially complementary, on the running surface of the belt wheel. In particular, the inclined flanks of the wedge ribs bear against similarly inclined flanks of the belt wheel. At the same time, the wedge ribs advantageously guide the belt in transverse direction on the belt wheel.

In that case, the more acute the wedge angle of the individual ribs the greater is, on the one hand, the pressing pressure for the same radial force and thus the traction capability. On the other hand, in a case of excessively acute wedge angles a jamming of the belt in the grooves of the belt wheel can occur. Such a jamming can, as a stick-slip effect, excite the belt into undesired vibrations which at the same time cause noise and increase the dynamic loading of the belt and the risk of running out of its guides. In the extreme case the jamming can also lead to failure of the elevator installation if the belt detaches only jerkily or no longer detaches from the grooves of the belt wheel.

### SUMMARY OF THE INVENTION

An object of the present invention is therefore to provide an elevator installation in which the risk of jamming between belt and belt wheel is reduced.

An elevator installation according to the present invention comprises an elevator car, a drive and, advantageously, a counterweight which is connected therewith and which lowers when the elevator car is raised by the drive, and conversely. Moreover, the elevator installation comprises a belt arrangement of at least one belt, wherein the belt has a belt body in which a tensile carrier arrangement is arranged and which has a first contact surface on a first cross-sectional side in the direction of the height of the belt and a second contact surface on a second cross-sectional side opposite the first cross-sectional side in the direction of the height of the belt.

The drive preferably comprises one or more belt wheels, particularly one or more drive pulleys or a drive shaft with several drive zones, which are looped around at least partly by the belts of the belt arrangement. Advantageously the belts loop around the belt wheels with an angle of wrap of 180°, preferably less than 180°, preferably less than 150°, preferably less than 120° and preferably 90°. By virtue of the small possible bending radii of the belts it is possible to have the drive connected with a separate drive pulley or, however, to integrate drive zones in a drive output shaft of the drive, thus a drive shaft. Advantageously, the diameter of the belt wheels is less than or equal to 220 millimeters, preferably less than 180 millimeters, preferably less than 140 millimeters, preferably less than 100 millimeters, preferably less than 90 millimeters and preferably less than 80 millimeters. The tension forces are introduced into the belt by the drive pulley or a drive shaft in friction-locking and/or shape-locking manner. If belts of the belt arrangement are constructed as wedge belts, the running surface of the belt wheels can have grooves which are of substantially complementary shape and in which the wedge ribs engage. Advantageously, in the case of grooves of substantially complementary shape the flanks of the wedge ribs bear in friction-coupling manner only against flanks of the grooves; the regions between the belt flanks, thereagainst, are not in contact with the groove bases and groove tips.

In an advantageous construction the belt body consists of an elastomer, for example PU and/or EPDM. For protection against abrasion and dynamic destruction the belt body can have one or more casings, for example of textile fabric.

The tensile carrier arrangement comprises a tensile carrier or preferably several tensile carriers, particularly steel and plastics material cords. The cords can be constructed as single wires or preferably built up from singly or multiply stranded wires. They are advantageously arranged in or near the neutral axis of the belt cross-section, in which during looping around of the belt wheel no, or only a few, tensile or compressive stresses arise.

A belt can be constructed as an endless belt or, preferably, as a finite belt, which is made endless only by a belt lock when placed and thus can be guided, particularly in difficult deflecting conditions, through, for example, openings or can be placed on belt wheels which are not mounted in alignment.

According to the present invention the ratio of the maximum width “w” to the maximum height “t” of the belt is selected to be substantially equal to one. In particular, it advantageously lies in the region of 0.8 to 1.0, preferably in the region of 0.9 to 1.0 and especially at 1.0. The belt is thus higher than wide.

With partial surrender of the advantages, which are mentioned in the introduction, of flat belts, particularly the flexibility thereof when looping around belt wheels, an elevator installation is thus made available with belts which have a greater geometrical moment of inertia in a belt transverse direction and thus are stiffer than conventional flat belts with respect to bending about the transverse axis. Such belts therefore experience, during deflection about a belt wheel, a higher biasing back into the straight, undeformed position. This biasing counteracts jamming of the belts at lateral flanks of the belt wheel and thus advantageously reduces the risk of jamming between belt and belt wheel. This effect is particularly advantageous in the case of wedge-ribbed belts, but can also reduce the risk of jamming with lateral guide cheeks of the belt wheels also in the case of flat belts.

A further advantage lies in the additional volume of the belt body in the direction of its height. This additional volume advantageously damps vibrations and dissipates shocks, which makes the running of such a belt more uniform.

The transmission of the circumferential force between tensile carriers and belt wheel takes place under transient deformation of the belt body in shear. The alternating deformations occurring in that case lead in the long term to destruction of the belt body and thus limit the service life of a belt. Here, too, the additional volume of the belt in the direction of its height can advantageously on the one hand reduce the shear deformations and on the other hand better dissipate arising heat over the greater volume and particularly over the greater surface, which overall advantageously increases the service life of a belt according to the invention.

In a preferred embodiment of the present invention the tensile carrier arrangement is arranged in the neutral axis approximately in the center of the belt.

In a further preferred embodiment the belt body comprises a first part belt, in which the tensile carrier is arranged, and a second part belt, which is fixedly connected therewith in a longitudinal surface. This can be extruded onto the first part belt, so that the two part belts are connected together at their longitudinal surface. In that case, as known from, for example, WO 2006/000500 A1, grooves in the longitudinal surface of the first part belt are filled up by the second part belt. Equally, the two part belts can be glued.

In an advantageous embodiment of the present invention the two part belts have substantially the same height, so that the longitudinal surface is arranged approximately in the center of the belt.

The first part belt preferably surrounds the tensile carrier arrangement entirely or partly. In the latter case, the second part belt also surrounds the tensile carrier arrangement in such a manner that it is arranged completely in the belt.

Insofar as the tensile carrier arrangement is advantageously arranged in the neutral axis, in which no tensile and compressive stresses occur on deflection around a belt wheel, i.e. a bending around the belt transverse axis, and the tensile carrier arrangement is arranged more in the first part belt, the second part belt during looping around a belt wheel experiences a greater loading in bending and therefore greater tensile or compressive stresses. In an advantageous embodiment the second part belt is therefore softer than the first part belt so that in the case of bending in the tensile carrier layer the second part belt is not damaged by tensile stresses, but this yields resiliently. In particular, the second part belt can have a lesser Shore hardness than the first part belt. Thus, for example, the Shore hardness of the first part belt can be 85 Sh and that of the second can be 80 Sh.

The first and/or second contact surface can preferably have a coating with a specific coefficient of friction. This coefficient of friction can be higher or lower in each instance than the coefficient of friction of the actual belt body. In particular, the coating can comprise a polyamide (PA) film.

For example, there can be arranged on the first contact surface, which is intended for engagement with a drive pulley or drive shaft, a coating with a higher coefficient of friction and on the second contact surface, which is intended for engagement with a deflecting element, a coating with lower coefficient of friction. Alternatively to the coating, a vapor deposition or a flocking can also be provided.

In a particularly preferred embodiment the first and/or second contact surface has or have at least one rib, preferably two ribs, particularly wedge ribs. Equally, triangular or semicircular rib cross-sections are also possible. In this particularly preferred embodiment the running surfaces of belt wheels, which are looped around by the belts, can advantageously have grooves which are substantially complementary to the ribs and in which the ribs engage. A higher pressing force and thus a higher traction capability can thus be achieved for the same radial force, i.e. the same belt bias or bearing loading.

The ribs preferably have a wedge-shaped cross-section with a flank angle of 60° to 120°, wherein the region from 80° to 100° is to be preferred. The angle present between two side surfaces (flanks) of a wedge-shaped rib is termed flank angle. However, by virtue of the greater stiffness relative to bendings about the belt transverse axis, flank angles below 60°, thus more acute angles, can also be realized.

If advantageously not only the first contact surface, but also the second contact surface have one or more ribs, the belt can, even in the case of deflection in an opposite sense around two belt wheels in which it contacts the first belt wheel by its first contact surface and the second belt wheel by its second contact surface, be guided in transverse direction during the looping around of the two belt wheels, which can advantageously avoid running-out of the belt from even pure deflecting rollers. The number of ribs on both contact surfaces does not necessarily have to be identical. Insofar as, for example, the first belt wheel is a drive pulley or drive shaft and the second belt wheel a deflecting roller, the second contact surface, over which no tensile forces are imposed, can have fewer ribs. In particular, the first contact surface can have two ribs and the second contact surface one rib. Obviously, the second contact surface can also be formed to be flat without contouring.

The first and second contact surfaces can have different colors, so as to ensure correct placing of the belt, particularly when the first and second contact surfaces are different, for example have different coefficients of friction, or equally when the first and second part belts are not completely identical, for example the tensile carriers are arranged more in the first part belt and/or this has a hardness different from that of the second tensile carrier. For this purpose, for example, the two contact surfaces can be colored or coded differently. Insofar as the belt is composed of two part belts, the two part belts can consist of materials of different color.

In a preferred embodiment the belt arrangement comprises several belts arranged adjacent to one another in the direction of their width. Advantageously, these belts can be connected together in mechanically positive manner. For this purpose, for example, a first belt can have a projection which protrudes in the direction of its width and which engages in a corresponding cut-out of a second belt arranged adjacent thereto. The belts can in this manner be connected together in simple manner and detachably during assembly, which simplifies mounting and demounting the narrower individual belts relative to the resulting belt arrangement. Equally, the belts can also be connected together by way of clamping elements or non-detachably fastened to one another, for example glued together.

Advantageously, for production of a belt according to the present invention a method is proposed comprising the following steps: extruding the first part belt in such a manner that it at least partly surrounds the tensile carrier arrangement, and extruding the second part belt onto the first part belt in such a manner that the tensile carrier arrangement is completely arranged in the belt. It is thereby advantageously possible, even with existing extruders designed for the production of flat belts with a width/height ratio greater than one, to produce, with slight modifications, belts according to the present invention with a width/height ratio substantially equal to one. The two part belts thermally interconnect by the extruding on, which produces a firm and permanent connection.

For mounting of a belt according to the present invention in an elevator installation it is proposed to connect together several belts by way of an assembly band to form a composite. Advantageously the belts in that case are at least partly surrounded by the assembly band and/or the assembly band is connected on a second contact surface with the belt. In addition, it is particularly advantageous if the belts are connected with the assembly band at defined assembly spacings from one another.

The actual method for mounting of the composite in an elevator installation comprises laying the composite on belt wheels and fixing the belts at ends of the composite to belt fixing points. Advantageously the belts of the composite are placed on the belt wheels in accordance with the assembly spacings. In that case it is particularly advantageous if the belts of the composite are placed in grooves of at least one car deflecting roller and/or grooves of at least one drive pulley or drive shaft and/or grooves of at least one counterweight support roller. In addition, it is simple and practical, for the mounting, to transport the composite as a loop into the elevator shaft and unroll it from the loop.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 shows a section, which is parallel to an elevator car front, through an elevator installation according to an embodiment of the present invention;

FIG. 2 shows a section through a belt of the elevator installation of FIG. 1 according to a first embodiment of the present invention, in the form of a wedge-ribbed belt;

FIG. 3 shows a section through a belt of the elevator installation of FIG. 1 according to a second embodiment of the present invention, in the form of a wedge-ribbed belt;

FIG. 4 shows a section through a belt arrangement of the elevator installation of FIG. 1 according to a third embodiment of the present invention;

FIG. 5 shows a section through a belt of the elevator installation of FIG. 1 according to a fourth embodiment of the present invention, in the form of a wedge-ribbed belt;

FIG. 6 shows a section through a composite of several belts of the first embodiment of the present invention according to FIG. 2;

FIG. 7 shows the elevator installation of FIG. 1 in a first assembly step;

FIG. 8 shows the elevator installation of FIG. 1 in a second assembly step;

FIG. 9 shows the elevator installation of FIG. 1 in a third assembly step;

FIG. 10 shows a section through a belt of the elevator installation of FIG. 1 according to a fifth embodiment of the present invention, in the form of a wedge-ribbed belt; and

FIG. 11 shows a section through a belt of the elevator installation of FIG. 1 according to a sixth embodiment of the present invention, in the form of a wedge-ribbed belt.

### DESCRIPTION OF THE PREFERRED EMBODIMENT

The U.S. provisional patent application Ser. No. 60/822,118 filed Aug. 11, 2006 is hereby incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

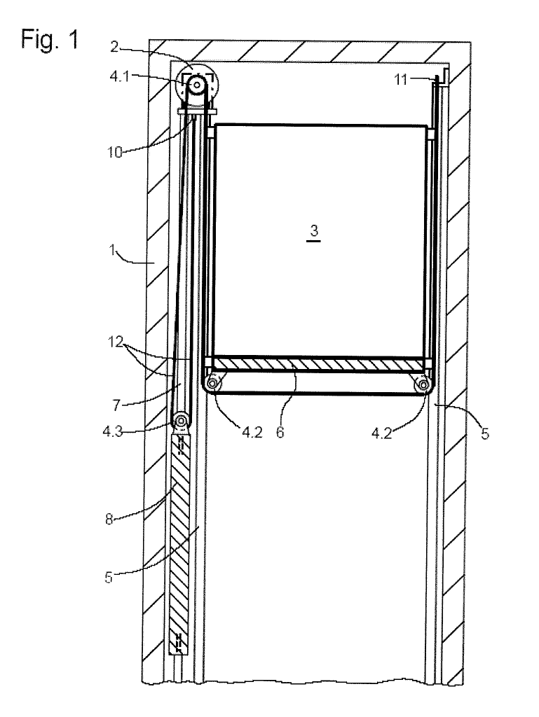

FIG. 1 shows a section through an elevator system, which is installed in an elevator shaft 1, according to an embodiment of the present invention. This comprises a drive 2, which is fixed in the elevator shaft 1, with a drive pulley or drive shaft 4.1, an elevator car 3, which is guided at car guide rails 5, with deflecting rollers mounted below the car floor 6 and in the form of car support rollers 4.2, a counterweight 8, which is guided at counterweight guide rails 7, with a further deflecting roller in the form of a counterweight support roller 4.3, and a support belt, which is constructed as a wedge-ribbed belt 12, for the elevator car 3 and the counterweight 8, which belt transmits the drive force from the drive pulley or drive shaft 4.1 of the drive unit 2 to the elevator car and the counterweight.

The wedge-ribbed belt 12 is fastened at one of its ends below the drive pulley or drive shaft 4.1 to a first belt fixing point 10. From this it extends downwardly to the counterweight support roller 4.3, loops around this and extends from this to the drive pulley or drive shaft 4.1, loops around this and runs downwardly along the car wall at the counterweight side, loops through 90° on either side of the elevator car around a respective car support roller 4.2 mounted below the elevator car 3 and runs upwardly along the car wall remote from the counterweight 8 to a second belt fixing point 11.

The plane of the drive pulley or drive shaft 4.1 can be arranged at right angles to the car wall at the counterweight side and its vertical projection can lie outside the vertical projection of the elevator car 3. It is therefore to be preferred that the drive pulley or drive shaft 4.1 has a small diameter of less than or equal to 220 millimeters, preferably less than 180 millimeters, preferably less than 140 millimeters, preferably less than 100 millimeters, preferably less than 90 millimeters and preferably less than 80 millimeters, so that the spacing between the left-hand car wall and the wall of the elevator shaft 1 opposite thereto can be as small as possible. Moreover, a small diameter of the drive pulley or drive shaft 4.1 enables use of a gearless drive motor with relatively low drive torque as the drive unit 2. The belt fixing points 10, 11 are devices which are known to the expert and in which the wedge-ribbed belt 12 is clamped between a wedge and a housing.

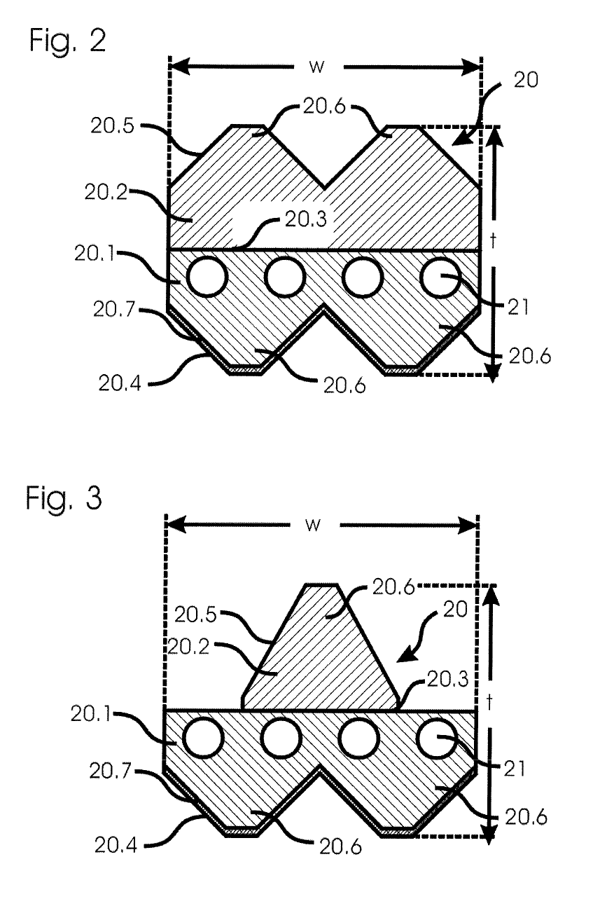

FIG. 2 shows a section through a belt of the elevator installation of FIG. 1, in accordance with a first embodiment of the present invention, in the form of a wedge-ribbed belt 12. This comprises a belt body 20, which has a first part belt 20.1 and a second part belt 20.2. The two part belts are fixedly connected together at a longitudinal surface 20.3. In FIG. 2 the longitudinal surface 20.3 is schematically drawn as planar. Although not illustrated, the longitudinal surface of a part body can, however, have recesses in which shaped-out portions of the other part body engage so as to reinforce the connection of the two part bodies.

A first contact surface 20.4 of the first part body is intended for contact with the drive pulley or drive shaft 4.1 and the counterweight roller 4.3. It has for this purpose two part ribs 20.6 which can engage in grooves, which are substantially complementary therewith, of the belt wheels 4.1, 4.3 and can be laterally guided by these. The pressing pressure and thus the traction capability of the drive 2 thereby advantageously increase.

A second contact surface 20.6 of the second part body 20.2 is intended for contact with the car support rollers 4.2 and has for this purpose in analogous manner two wedge ribs 20.6 which can engage in grooves, which are substantially complementary therewith, of the belt wheels 4.2 and can be laterally guided by these. In a second embodiment illustrated in FIG. 3 the second contact surface has only one rib 20.6, which is sufficient for lateral guidance of the belt 12 in the car support rollers 4.2.

Four tensile carriers 21 in the form of stranded steel wires are arranged adjacent to one another in the first part belt 20.1. Equally, also more, for example, five, tensile carriers or less, for example three, tensile carriers can be arranged adjacent to one another. The individual tensile carriers can equally well also be arranged to be offset relative to one another in the direction of the height of the belt 12.

The tensile carriers are arranged in the neutral axis of the belt body 20 in which no tensile or compressive stresses occur when the belt 12 loops around a belt wheel, particularly the drive pulley or drive shaft 4.1. By virtue of this greater spacing of the second contact surface 20.5 from this neutral axis the tensile stresses arising in the second part belt 20.2 when looping around are greater than the compressive stresses present in the first part belt 20.1. A softer elastomer is therefore selected as material for the second part belt, in the example of embodiment with a Shore hardness of 80 Sh relative to a Shore hardness of 85 Sh of the first part belt. In the second embodiment according to FIG. 3 the second part belt is smaller in cross-section than the first and has, in particular, only the one wedge rib 20.6. It is also thereby correspondingly softer than the first part belt.

The first contact surface 20.4 has, at least in the regions of its wedge ribs 20.6 coming into friction couple with the flanks of the drive pulley or drive shaft 4.1, a coating 20.7 with a PA film. Advantageously the entire first contact surface 20.4 is coated in a continuous or discontinuous process, which simplifies production. Alternatively to the coating 20.7, a vapor deposition 20.7 or a flocking 20.7 can also be provided. The vapor deposition is, for example, a metal vapor deposition. The flocking is, for example, a flocking with short synthetic or natural fibers. This vapor deposition or flocking can also extend over the entire first contact surface 20.4 and be carried out in a continuous or discontinuous process. In principle, it is also possible with pairings, which are formed to be substantially complementary, of wedge ribs and grooves in which only the flanks of the wedge ribs bear in friction-coupling manner against the ribs, to provide only these flanks of the wedge ribs with the coating 20.7, or vapor deposition 20.7 or flocking 20.7, so that the regions between the belt flanks, which are not, in fact, in contact with the groove bases and groove tips, are uncoated.

According to the present invention the ratio of the maximum width w to the maximum height t of the belt body inclusive of the wedge ribs 20.6 lies in the region of 0.8 to 1.0. In the example of embodiment the ratio is substantially equal to one. The belt 12—even in the case of the second embodiment shown in FIG. 3—is thereby stiffer relative to bendings about its transverse axis. The higher bias, which results therefrom, when looping around a belt wheel with grooves reduces the risk of jamming of the belt in the belt wheel. Other relationships of the maximum width w to the maximum height t of the belt body inclusive of the wedge ribs 20.6 in the region of 0.6 to 1.0 are obviously also possible with knowledge of the present invention.

The second part belt damps oscillations and absorbs shocks. Beyond that, it reduces shear stresses in the first part belt, which occur on transmission of tension forces to the tensile carriers. Finally, by virtue of its additional volume and its surface area it increases the heat dissipation. Thus, the service life of a belt according to the invention is advantageously increased.

The drive pulley or drive shaft 4.1, the car support rollers 4.2 and the counterweight support roller 4.3 are provided at their periphery with grooves which are formed to be substantially complementary to the grooves of the wedge-ribbed belt 12. Where the wedge-ribbed belt 12 at least partly loops around the belt wheels 4.1, 4.2 or 4.3 its ribs in lie in corresponding grooves of the belt wheel, whereby excellent guidance of the wedge-ribbed belt on this belt wheel is ensured. Moreover, traction capability is improved by a wedge action arising between the grooves of the drive pulley or drive shaft 4.1 and the ribs of the wedge-ribbed belt 12.

By contrast to conventional elevator installations, in the looping around the car support rollers 4.2 below the elevator car 3 a lateral guidance between the car support rollers 4.2 and the wedge-ribbed belt 12 is therefore also given, since the wedge-ribbed belt also has ribs on its side remote from the car support rollers 4.2.

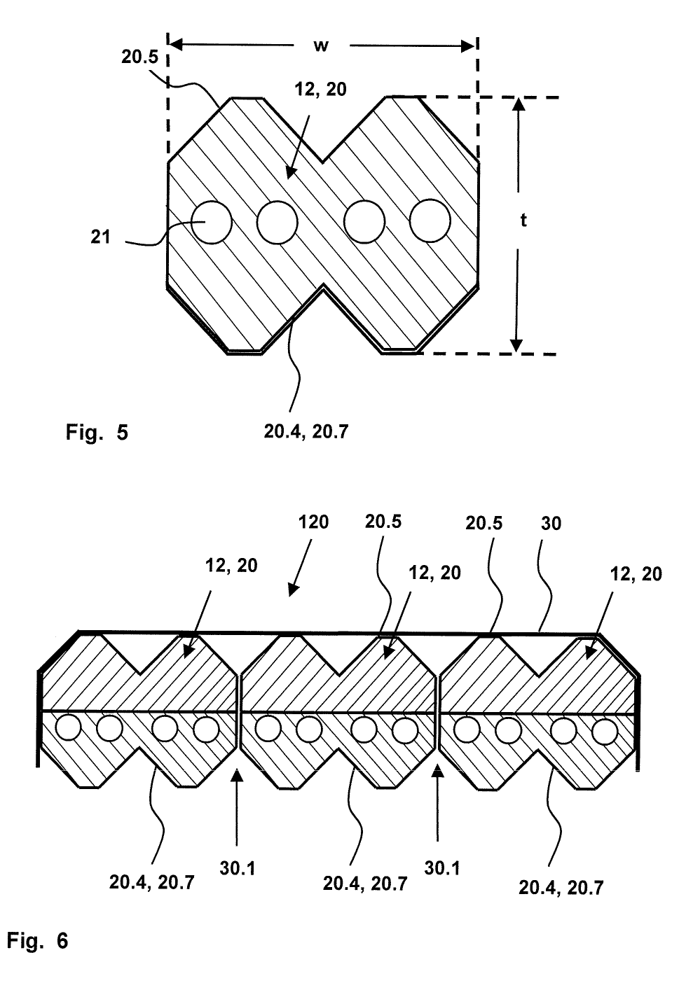

In the form of embodiment according to FIG. 5 the tensile carriers 21 are arranged in the neutral axis approximately in the center of the belt 12. In this form of embodiment the belt body 20 does not consist of part belts. The elastomer material is extruded onto the tensile carrier arrangement 21 in such a manner that it entirely or partly surrounds this arrangement and the tensile carrier arrangement 21 comes to lie in the belt body 20 approximately centrally with respect to the maximum height t. This form of embodiment otherwise corresponds with that according to FIGS. 2 to 4.

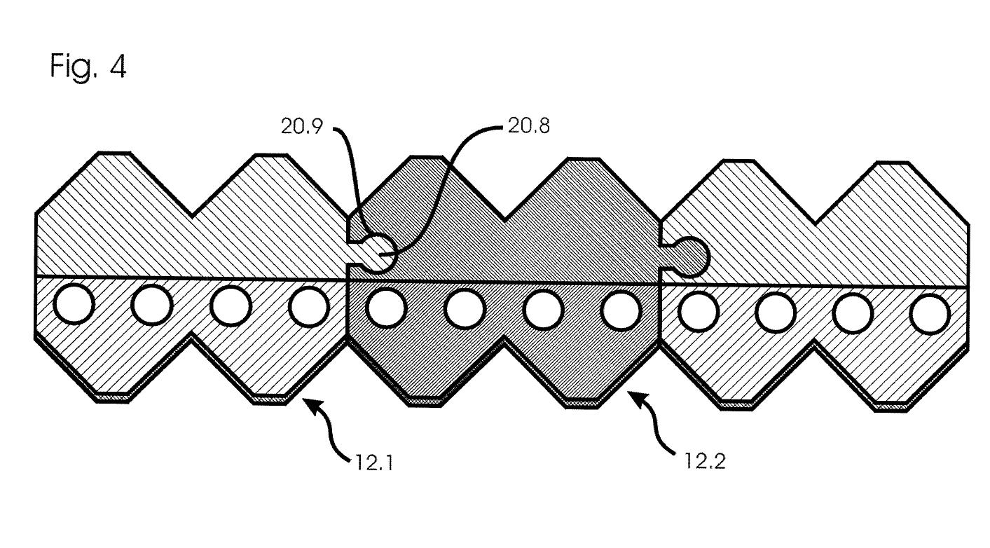

Although not recognizable in FIG. 1, a belt arrangement in an elevator installation according to the present invention can comprise more than one belt. FIG. 4 shows for this purpose a preferred embodiment of such a belt arrangement. In that case in each instance at least one projection 20.8 of a first belt 12.1 engages in a corresponding cut-out 20.9 of an adjacent second belt 12.2, which further improves lateral guidance and prevents twisting or distorting of the entire belt arrangement particularly in the region of the free run. In an alternative embodiment, which is not illustrated, the second belt 12.2 can also have, at both transverse sides, projections which engage in corresponding cut-outs of the adjacent belt. Advantageously, the outermost belts of a belt arrangement connected together by projections have no cut-out or no projection.

Through such a belt arrangement, a belt arrangement of any width can be assembled simply and quickly in situ from narrow individual belts able to be easily handled, which significantly simplifies production and stock-keeping, transport and mounting/demounting.

For production of a belt according to the present invention initially the first part belt 20.1 can be extruded in such a manner that it entirely or completely surrounds the tensile carrier arrangement 21. In a succeeding second step the second part belt 20.2 can then be extruded onto the first part belt 20.1 in such a manner that the tensile carrier arrangement is completely arranged in the belt. It is thus advantageously possible to use existing machines, which are used for production of a belt of which the width exceeds its height, for example in the form of the first part belt 20.1, with small modifications also for production of a belt according to the invention with a width/height ratio of approximately one.

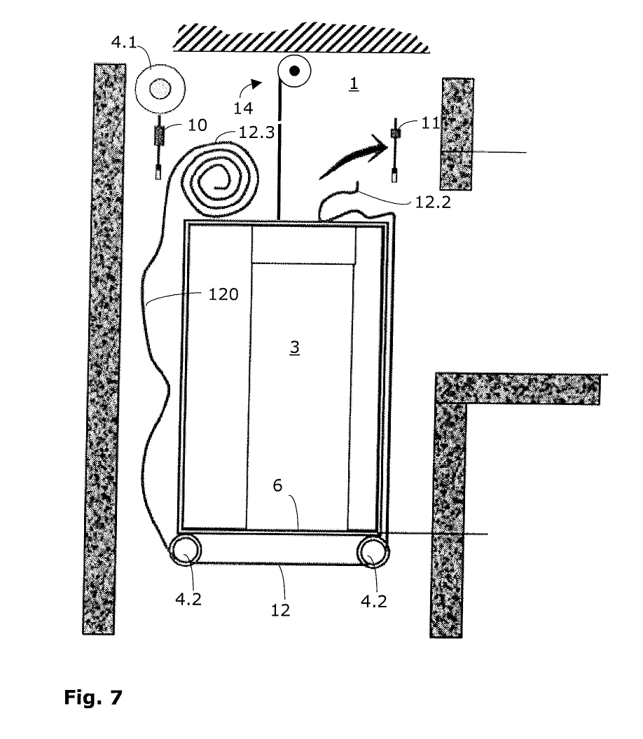

FIGS. 6 to 9 relate to mounting of the belt 12 in an elevator installation. FIG. 6 shows several belts 12 which are connected together by way of an assembly band 30. The assembly band 30 surrounds the belt 12 at least partly. For example, three, four or six or even eight belts 12 form a composite 120 which is partly surrounded by assembly band 30 and which can be transported rolled up as a loop in simple and problem-free manner into the elevator shaft 1. The assembly band 30 is, for example, fixed reversibly or irreversibly in material-locking manner to the belts 12. Advantageously it is a thin synthetic material band with an adhesive layer at one side. The synthetic material band is connected with the belts 12 by way of the adhesive layer. The reversible material lock can allow withdrawal of the adhesive band 30 from the belt 12 and thus separate the detached belts 12. Advantageously, the assembly band 30 is mounted on the second contact surface 20.5, which is remote from the first contact surfaces 20.4, of the belt body 20 so that the contact surfaces 20.4 of the individual belts 12 are also freely accessible in the composite 120. In particular, the individual belts 12 in the composite 120 can lie by their contact surfaces 20.4 in corresponding grooves of the belt wheels. In that case the assembly band 30 also guarantees correct lateral spacing of the belts 12 from one another on the belt wheels. For this purpose the belts 12 are connected with the assembly band 30 at lateral assembly spacings 30.1 from one another which correspond with the lateral spacings of the individual belts 12 on the belt wheels.

The following steps are carried out for mounting of the composite 120 in the elevator installation: the composite 120 is placed on belt wheels 4.1, 4.2, 4.3 and belts 12 are fixed at ends 12.1, 12.2 of the composite 120 to belt fixing points 10, 11. In that case the belts 12 of the composite 120 are laid on belt wheels 4.1, 4.2, 4.3 in accordance with assembly spacings 30.1.

For this purpose it is advantageous to use an auxiliary hoist 14 which in the present example of FIGS. 7 to 9 is fastened to the ceiling of the elevator shaft 1. Equipment of block-and-tackle kind mounted in the uppermost shaft region is preferably used as auxiliary hoist 14. It would also be possible to use a fluid elevatoring device (for example, a hydraulic system) arranged in the lowermost shaft region or also a building crane.

The elevator car 3 is present at least in structural form. The final production of the elevator car 3 can take place later. The elevator car 3 has a floor plate or a lower structural part with a lower surface 6, at which first car deflecting rollers 4.2 and second car deflecting rollers 4.2 are arranged, as well as a ceiling plate (or an upper structural part), which in the present example forms a kind of work platform. The work platform can also be formed by the floor plate of the elevator car 3 if the existing structural form of the elevator car 3 still does not include side walls.

The elevator car 3 can be coupled to the auxiliary hoist 14 and movable upwardly and downwardly by this in the elevator shaft 1. As soon as the elevator car is coupled and fixed to the auxiliary hoist 14 the composite 120 according to FIG. 6 is placed in the elevator shaft 1.

According to FIG. 7 the composite 120 is transported in the form of a loop 12.3 onto the roof of the elevator car 3, deposited there and partly unrolled. Advantageously the elevator car 3 is for this purpose disposed in the shaft pit, so that the engineer can lay the loop 12.3 in simple manner on the roof of the elevator car 3 from the ground floor of the building. One end 12.2 of the unrolled composite 120 is let down at one side of the elevator car 3, led below the elevator car 3 to the opposite side of the elevator car 3 and from there guided up again to the roof of the elevator car 3. The engineer can obviously also initially lay the composite 120 around the car support rollers 4.2 and then deposit the loop 12.3 on the roof of the elevator car 3. The belts 12 of the composite 120 are now inserted by way of the contact surfaces 20.4 into the corresponding grooves of the car support rollers 4.2. Anti-jump protection means, which are not illustrated in the figures and which prevent jumping out of the belts 12 not only in radial direction, but also in axial direction when the support means are loose, are optionally also mounted at the car support rollers 4.2. The end 12.2 is provisionally fixed on the roof of the elevator car 3. The elevator car 3 is now moved by the auxiliary hoist 14 to the shaft head. The individual belts 12 of the end 12.2 are individually definitively fixed in each instance to a respective second belt fixing point 11.

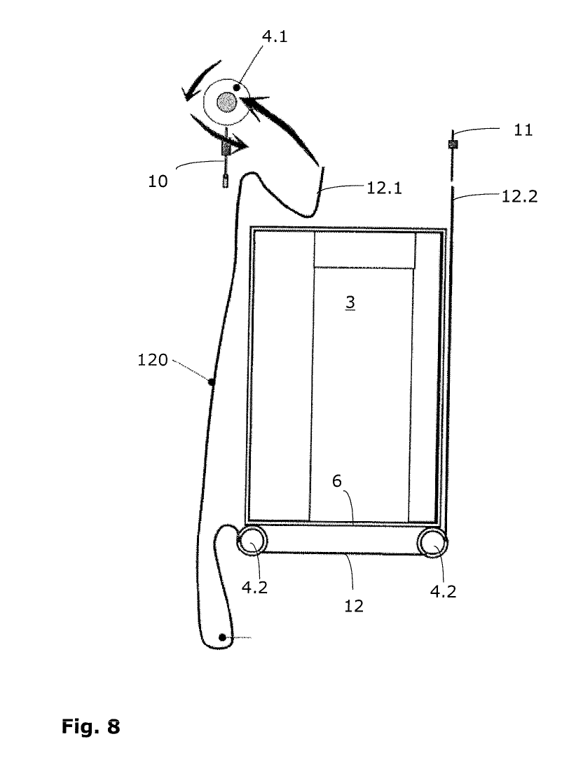

In the further assembly step according to FIG. 8 the loop 12.3 is unrolled from the roof of the elevator car 3 into the pit of the elevator shaft. In that case the other end 12.2 of the unrolled composite 120 is held fast and led around the drive pulley or drive shaft 4.1 and let down into the pit of the elevator shaft. If sufficient space is present, the engineer can also guide the entire loop 12.3 around the drive pulley or drive shaft 4.1 and then let it down into the pit of the elevator shaft. The belts 12 of the composite 120 are now inserted by way of the contact surfaces 20.4 into the corresponding grooves of the drive pulley or drive shaft 4.1. Optional anti-jumping protection means are again mounted at the drive pulley or drive shaft 4.1.

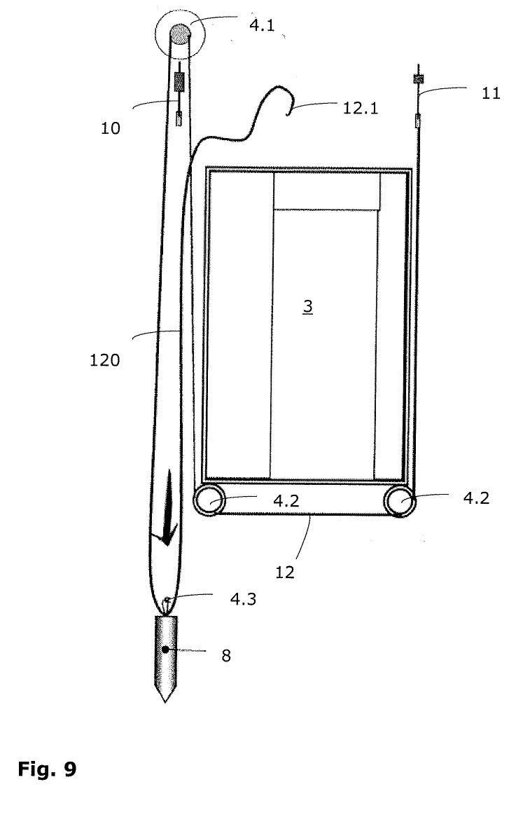

In the following mounting step according to FIG. 9 the other end 12.1 of the composite 120 is placed, in the shaft pit, around a counterweight support roller 4.3. The elevator car 3 is moved by the auxiliary hoist 14 into the shaft pit and the other end 12.1 is provisionally fixed to the roof of the elevator shaft 3. The elevator car 3 is thereupon moved by the auxiliary hoist 14 to the shaft head and the belts 12 of the composite 120 are inserted by way of the contact surfaces 20.4 into the corresponding grooves of the counterweight support roller 4.3. Anti-jump protection means are optionally mounted at the counterweight support roller 4.3. The individual belts 12 of the other end 12.1 are now individually definitively fixed in each instance to a respective first belt fixing point 10. Only at this point in time, where the belts 12 are completely laid in the elevator shaft 1, can the assembly band 30 be removed from the composite 120.

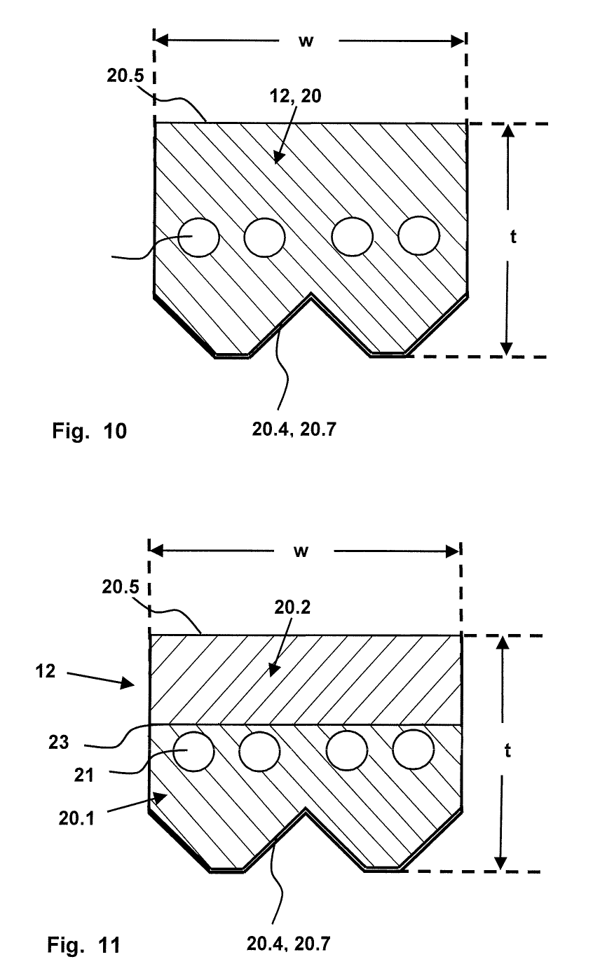

The fifth form of embodiment of the present invention with a belt 12 according to FIG. 10 substantially corresponds with that according to FIG. 5, so that reference is made to the description for FIG. 5. In sole distinction from the form of embodiment according to FIG. 5, in the form of embodiment according to FIG. 10 the belt body 20 is formed on the second cross-sectional side with a flat second contact surface 20.5. This flat second contact surface 20.5 does not have any profiling in the form of transverse or longitudinal ribs.

Finally, the sixth form of embodiment of the present invention with a belt 12 according to FIG. 11 corresponds with that according to FIG. 10, wherein in sole distinction from the form of embodiment according to FIG. 10 the belt body according to FIG. 11 consists of two part belts 20.1, 20.2 as described and illustrated in the forms of embodiment according to FIGS. 2 to 4 and 6. The flat second contact surface 20.5 is arranged parallel to the longitudinal surface 20.3. The tensile carrier arrangement 21 comes to lie approximately centrally with respect of a maximum height t of the belt body.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator installation with an elevator car, a drive and a belt arrangement with at least one belt, wherein the belt has a belt body in which a tensile carrier arrangement is arranged and which has a first contact surface on a first side in a direction of a height of the belt and a second contact surface on a second side opposite the first side in the direction of the height of the belt, comprising: the belt body having a ratio of width to the height in range of 0.8 to 1.0.

2. The elevator installation according to claim 1 wherein the tensile carrier arrangement lies approximately centrally in the belt body with respect to the height direction.

3. The elevator installation according to claim 1 wherein the belt body has a first part belt in which the tensile carrier arrangement is arranged and a second part belt fixedly connected therewith at facing longitudinal surfaces.

4. The elevator installation according to claim 3 wherein said second part belt is less hard than said first part belt.

5. The elevator installation according to claim 1 wherein at least one of the first contact surface and the second contact surface has a coating with a predetermined coefficient of friction.

6. The elevator installation according to claim 1 wherein at least one of the first contact surface and the second contact surface has a vapor deposition with a predetermined coefficient of friction.

7. The elevator installation according to claim 1 wherein at least one of the first contact surface and the second contact surface has a flocking with a predetermined coefficient of friction.

8. The elevator installation according to claim 1 wherein the first contact surface has at least one rib formed thereon.

9. The elevator installation according to claim 1 wherein the second contact surface has at least one rib formed thereon.

10. The elevator installation according to claim 1 wherein the second contact surface is substantially flat.

11. The elevator installation according to claim 1 wherein the first contact surface and the second contact surface are different colors.

12. The elevator installation according to claim 1 wherein the belt arrangement comprises a plurality of the belts arranged adjacent to one another in a direction of the width and which are connected together in a mechanically positive manner.

13. A belt for an elevator installation comprising:
a belt body; and
a tensile carrier arrangement arranged in said belt body, said belt body having a first contact surface on a first side in a direction of a height of the belt and a second contact surface on a second side opposite the first side in the direction of the height of the belt, wherein a ratio of a width to a height of the belt lies in a range of 0.8 to 1.0.

14. A method of producing the belt according to claim 13 comprising the steps of:
a) extruding a first part belt at least partly surrounding the tensile carrier arrangement; and
b) extruding a second part belt onto the first part belt whereby the tensile carrier arrangement is completely arranged in the belt.

15. A composite having a plurality of the belts according to claim 13 wherein the belts are connected together by an assembly band.

16. The composite according to claim 15 wherein the belts are at least partly surrounded by said assembly band or the assembly band is connected on the second contact surfaces of the belts.

17. The composite according to claim 15 wherein the belts are connected at assembly spacings from one another with the assembly band.

18. A method for mounting of the composite according to claim 15 in an elevator installation, comprising the steps of:
a) placing the composite on belt wheels; and
b) fixing the belts at ends of the composite to belt fixing points.

19. The method according to claim 18, wherein the composite is placed on the belt wheels with assembly spacings between the belts.

20. The method according to claim 18 wherein the belts of the composite are placed in at least one of grooves of at least one car deflecting roller, grooves of at least one drive pulley or drive shaft, or grooves of at least one counterweight support roller.

21. The method according to claim 18 wherein the composite is transported into an elevator shaft as a loop and is unrolled from the loop for installation.
